(19) United States
(12) Patent Application Publication
(10) Pub. No.: US 2022/0292797 A1
(43) Pub. Date: Sep. 15, 2022

(54) DETECTION SYSTEM AND METHOD FOR MOTOR VEHICLE PASSENGER COMPARTMENT

(71) Applicant: Faurecia Clarion Electronics Europe, Paris (FR)

(72) Inventor: Omar BEN ABDELAZIZ, Tille (FR)

(21) Appl. No.: 17/691,073

(22) Filed: Mar. 9, 2022

(30) Foreign Application Priority Data
Mar. 9, 2021 (FR) FR21 02283

(51) Int. Cl. G06V 10/143; G06V 20/59

(52) U.S. Cl. CPC G06V 10/143; G06V 20/597; G06V 40/20

(57) ABSTRACT

A detection system that includes: an image capture apparatus configured to capture images of a scene located in the passenger compartment and a projection system configured to project structured light on the scene. The projection system has at least one projection device, each projection device being separate from the image capture apparatus so as to be mounted in the passenger compartment while being offset relative to the image capture apparatus. Each projection device is configured to project at least one structured light pattern. The detection system further includes an electronic control unit configured to analyze images captured using the image capture apparatus during the projection of one or several structured light pattern(s).

### TECHNICAL FIELD

The present invention relates to a detection system for a motor vehicle passenger compartment.

### BACKGROUND

It is possible to equip a motor vehicle with a detection system by image analysis, comprising a camera arranged so as to capture images of a scene located in the passenger compartment of the motor vehicle, a projection device for projecting a light pattern on the scene, and a data processing unit configured to analyze the images so as to determine characteristics of the scene inside the passenger compartment.

Such a detection system may for example be used to detect the presence of one or several occupants in the motor vehicle, to detect the presence of the driver of the motor vehicle, to detect signs of fatigue of the driver of the motor vehicle, for example by analyzing the face and/or the behavior of the driver, and/or to verify that the driver is attentive despite the use of a driver assistance system, for example by verifying that the driver is keeping his hands on the steering wheel.

The structured light pattern differs from uniform lighting. It for example comprises illuminated zones and non-illuminated zones. A structured light pattern is for example a striped light pattern comprising alternating illuminated bands and non-illuminated bands, or a set of light points.

In a known manner, the projection of such a structured light pattern facilitates the analysis of images captured by the data processing unit, by allowing easy detection of the deformations of the structured light pattern in the images.

### SUMMARY

One aim of the invention is to propose a detection system that allows easier analysis of the situation presented in the scene.

To this end, the invention proposes a detection system for a vehicle passenger compartment, the detection system comprising an image capture apparatus configured to capture images of a scene located in the passenger compartment, a projection system configured to project structured light on the scene, the projection system comprising at least one projection device, each projection device being separate from the image capture apparatus so as to be mounted in the passenger compartment while being offset relative to the image capture apparatus, each projection device being configured to project at least one structured light pattern, and an electronic control unit configured to analyze images captured using the image capture apparatus during the projection of one or several structured light pattern(s).

Using a projection device that is offset relative to the image capture apparatus allows the projection device to be positioned appropriately to improve the precision of the analysis of the captured images.

It is for example possible to position the projection device relative to the scene so as to limit the deformations of the light pattern that are due to the projection of the light pattern, for example by arranging the projection device such that it is closer to a specific element of the scene than the image capture apparatus is.

In specific example embodiments, the detection system comprises one or more of the following optional features, considered individually or according to any technically possible combination:
the projection system is configured to project at least two different structured light patterns;
   the projection system is configured to emit each of the structured light patterns in a respective range of wavelengths, separate from that of each other structured light pattern;

the projection system comprises at least two separate projection devices, each of the projection devices being configured to emit a structured light pattern different from the structured light pattern emitted by each other projection device;

each of the projection devices is configured to emit a structured light pattern in a range of wavelengths separate from that in which the structured light pattern projected by each other projection device is projected;

at least one projection device of the projection system is configured to emit at least two different structured light patterns;

at least one projection device is configured to emit at least two different light patterns in separate respective wavelength ranges;

at least one or each projection device configured to emit at least two different light patterns comprises at least two light sources, the projection device being configured to emit each structured light pattern using a respective light source among the light sources of the projection device;

each light source is configured to emit light in a respective wavelength range, different from that of each other light source of the projection device;
at least one projection device of the projection system comprises an optical filtering assembly arranged to filter light emitted by one or each light source of this projection device;
the optical filtering assembly defines, for the or each light source of the projection device, through zones allowing light emitted by this light source to pass and zones blocking the light emitted by this light source so as to form the elementary structured light pattern associated with this light source;
the projection device having at least two light sources, the through zones associated with each light source are separate from the through zones associated with each other light source of the projection device;
at least one or each projection device configured to emit at least two different light patterns is configured to emit a combined structured light pattern generated using at least two of the light sources of this projection device, by simultaneously projecting the elementary structured light patterns associated with these light sources;
the electronic control unit is configured to analyze the images captured by the image capture apparatus so as to detect the presence and/or the absence of a person or an animal in the vehicle after the vehicle is stopped, to detect physical and/or physiological parameters of a person or an animal present in the vehicle and/or to detect signs of fatigue or inattention by a driver, to detect the presence of an object in the passenger compartment, in particular interior layout elements of the vehicle, to detect a seatbelt not worn by an occupant, to detect discomfort by an occupant of the vehicle, to detect a change of driver, to detect a driver located outside a safe zone, to perform facial recognition of one or several occupant(s), in particular of the driver, to detect a gestural command and/or to detect the absence of a forgotten object.

The invention also relates to a vehicle, in particular a motor vehicle, equipped with a detection system as defined above.

### BRIEF DESCRIPTION OF THE DRAWINGS

The invention and its advantages will be better understood upon reading the following description, provided solely as a non-limiting example and done in reference to the appended drawings, in which:

FIG. 1 is a schematic view of a motor vehicle equipped with a detection system by image analysis;

FIG. 2 is a schematic view of a projection device of the detection system;

FIG. 3 is a schematic view of a projection device of the detection system;

FIG. 4 is a schematic view of an optical filtering assembly of the projection device of FIG. 3;

FIGS. 5 to 7 illustrate structured light patterns projected using the projection device of FIG. 3.

### DETAILED DESCRIPTION

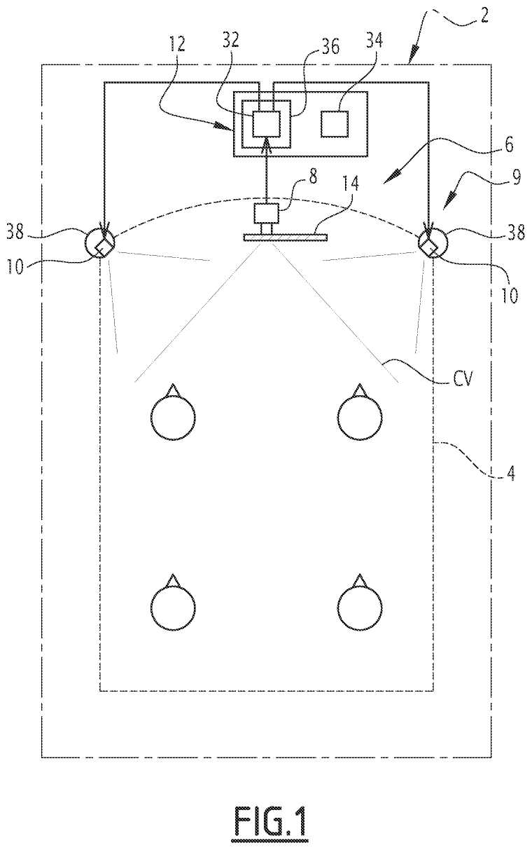

The motor vehicle 2 illustrated in FIG. 1 has a passenger compartment 4 in which occupants are present.

The motor vehicle 2 is equipped with a detection system 6 configured to determine characteristics of a scene located in the passenger compartment 4.

The scene for example includes each of the seats of the passenger compartment 4 that may be occupied by an occupant, or only some of these seats, for example one or all of the front seats, in particular the driver's seat.

The detection system 6 comprises an image capture apparatus 8 for capturing images of the scene, a projection system 9 configured to project structured light on the scene, and an electronic control unit 12 configured to analyze the images captured by the image capture apparatus 8 during the projection of structured light by the projection system 9.

The image capture apparatus 8 is for example a photographic device or a camera.

The image capture apparatus 8 has a field of view CV. The image capture apparatus 8 is positioned in the passenger compartment 4 such that its field of view CV corresponds to the scene in which one wishes to conduct a detection using the detection system 6.

In one example embodiment, the image capture apparatus 8 is positioned at the front of the passenger compartment 4 and oriented toward the rear of the passenger compartment 4. This for example allows the occupants of the vehicle 2 to be seen from the front in the images captured by the image capture apparatus 8, and their faces to be analyzed.

The image capture apparatus 8 is for example positioned in the middle of the passenger compartment 4 along a transverse direction of the vehicle 2 and/or in height. This allows all occupants to be seen.

In one particular example embodiment, the image capture apparatus 8 is positioned on or near an interior rearview mirror 14, for example on the windshield or on a roof lining.

The projection system 9 comprises one or several projection device(s) 10, each projection device 10 being configured to project at least one structured light pattern.

Each projection device 10 is separated from the image capture apparatus 8 so as to be able to be mounted in the passenger compartment 4 while being offset relative to the image capture device 8.

Each projection device 10 assumes the form of a module that is independent from the image capture apparatus 8 for assembly thereof in the passenger compartment 4.

Each projection device 10 is housed in a housing 40 separate from a housing of the image capture apparatus 8, and preferably dedicated to this projection device 10.

Each projection device 10 can be mounted in a location of the passenger compartment 4 separate from the location where the image capture apparatus 8 is mounted, in particular located at a distance from the image capture apparatus 8.

In one example embodiment, each projection device 10 is mounted in the passenger compartment 4 relative to an element of interest of the scene, for example a seat, in particular a front seat, such that the distance between the element of interest and this projection device 10 is strictly less than the distance between the element of interest and the image capture apparatus 8.

In one example embodiment, the projection system 9 comprises at least one projection device 10 mounted on a lateral upright of the vehicle, in particular on a front lateral upright of the vehicle or a central lateral upright of the vehicle.

Mounting a projection device 10 on a lateral upright of the vehicle allows the projection device 10 to be positioned near a seat of the vehicle adjacent to this lateral upright in order to allow projection of a structured light pattern in an appropriate manner to detect the presence of a passenger in the seat and/or to determine characteristics of this passenger.

In particular, mounting a projection device 10 on a front lateral upright (or “upright A”) of the vehicle allows the projection device 10 to be positioned near a front seat of the vehicle and mounting a projection device 10 on a central lateral upright (or “upright B”) allows the projection device 10 to be positioned near a rear seat of the vehicle.

Advantageously, the projection system 9 is configured to project at least two different structured light patterns.

The projection system 9 is preferably configured to selectively emit each structured light pattern individually (without emitting another light pattern at the same time) and/or to simultaneously emit at least two light patterns chosen among the structured light patterns.

For example, a first structured light pattern M1 is formed by light points and a second structured light pattern M2 is formed by parallel light bands separated by dark bands.

Different structured light patterns can be adapted to detect different characteristics of the scene and/or to detect characteristics of the scene with a different precision, in particular to perform a low-resolution detection (e.g. light band patterns) and a high-resolution detection (e.g. light pattern with points).

A structured light pattern formed by points is for example suitable for detecting the presence of passengers in the passenger compartment or for detecting (and tracking) a hand in the passenger compartment, for example for a gestural command of a functional member of the vehicle, for example an infotainment system.

A structured light pattern formed by parallel light bands is for example suitable for detecting relative distance between various objects in the passenger compartment, for example the distance between the head of an occupant and the headrest of the seat occupied by the occupant or the distance between the back of an occupant and the backrest of the seat occupied by the occupant.

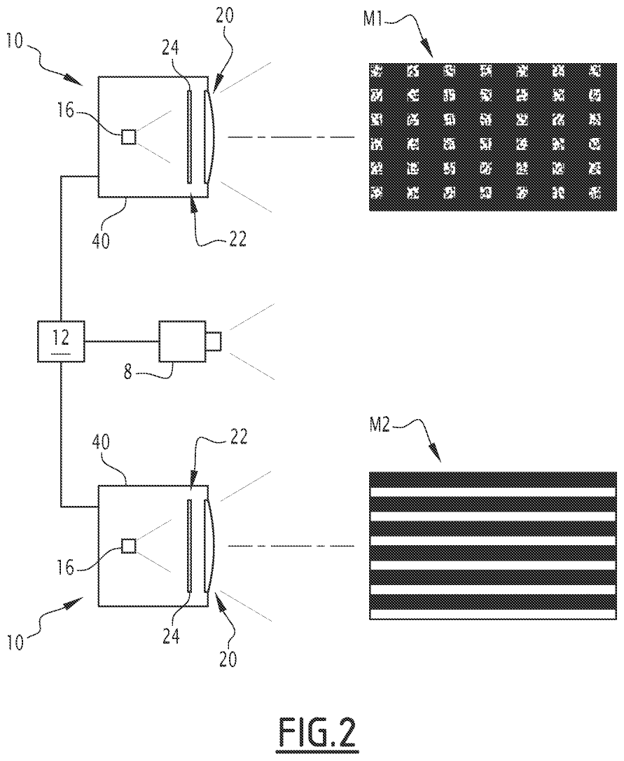

In one example embodiment, as illustrated in FIG. 2, the projection system 9 is configured to emit two structured light patterns M1, M2.

The projection system 9 for example comprises at least two projection devices 10, among which each projection device 10 is configured to emit a respective structured light pattern M1, M2 different from the structured light pattern emitted by each other projection device 10.

As illustrated in FIG. 1, the projection system 9 for example comprises two projection devices 10, each projection device 10 being configured to emit a respective structured light pattern M1, M2, different from that emitted by the other projection device 10.

The first light pattern M1 is for example formed by light points spaced apart from one another, and the second structured light pattern M2 is for example formed by parallel light bands alternating with dark bands.

In a first usage configuration, the projection device 10 projecting the first structured light pattern M1 is active and the projection device 10 projecting the second structured light pattern M2 is inactive, such that only the first structured light pattern M1 is projected on the scene.

In a second usage configuration, the projection device 10 projecting the first structured light pattern M1 is inactive and the projection device 10 projecting the second structured light pattern M2 is active, such that only the second structured light pattern M2 is projected on the scene.

Optionally, in a third usage configuration, the projection device 10 projecting the first structured light pattern M1 and the projection device 10 projecting the second structured light pattern M2 are active simultaneously, such that the first structured light pattern M1 and the second structured light pattern M2 are projected simultaneously on the scene.

The electronic control unit 12 is configured to analyze the scene from images captured by the image capture apparatus 8 using the first light pattern M1 and the second light pattern M2 projected individually or simultaneously.

Preferably, the projection system 9 is configured to project each structured light pattern M1, M2 with light outside the visible domain, in particular light in the near infrared domain.

In particular, each projection device 10 is configured to project each structured light pattern M1, M2 projected by this projection device with light outside the visible domain, in particular light in the near infrared domain.

Thus, each light pattern projected by the projection system 9 is invisible for the occupant(s) of the vehicle.

The visible domain corresponds to the wavelengths comprised between 380 nm and 780 nm. The near infrared domain corresponds to the wavelengths comprised between 780 nm and 1400 nm.

The image capture apparatus 8 is sensitive to radiation in the wavelength range in which each structured light pattern M1, M2 is projected. Each structured light pattern M1, M2 is thus visible in an image captured by the image capture apparatus 8 during the projection of this structured light pattern M1, M2.

The image capture apparatus 8 is for example sensitive to radiation in the near infrared domain. This is in particular a camera or a photographic device of the NIR (Near InfraRed) type.

As illustrated in FIG. 2, each projection device 10 for example comprises a light source 16 and an optical objective 20 comprising an optical filter 24 configured to generate the structured light pattern M1, M2 when the light source 16 is turned on.

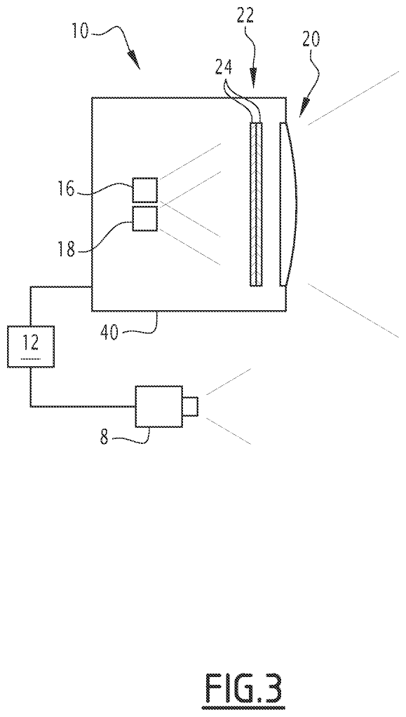

In one example embodiment, as illustrated in FIG. 3, the projection system 9 comprises at least one projection device 10, here a projection device 10, configured to project two different structured light patterns M1, M2.

Each projection device 10 comprises at least two light sources, here two light sources 16, 18, and is configured to emit a respective elementary structured light pattern using each light source 16, 18, each elementary structured light source projected using one of the light sources 16, 18 being predetermined and different from the elementary structured light source projected using each other light source 16, 18 of the projection device 10.

Preferably, each of the light sources 16, 18 of the projection device 10 is configured to emit light outside the visible domain, for example in the near infrared domain.

In one example embodiment, the light sources 16, 18 of the projection device 10 emit light in different respective wavelength ranges. The range of wavelengths in which each light source 16, 18 of the projection device 10 emits light is different from the range of wavelengths in which each other light source of the projection device 10 emits light.

Preferably, the light sources 16, 18 of the projection device 10 emit light in separate wavelength ranges. The range of wavelengths in which each light source 16, 18 of the projection device 10 emits light is separate from the range of wavelengths in which each other light source of the projection device 10 emits light.

Advantageously, each projection device 10 comprises a common optical objective 20 by means of which the light generated by each light source 16, 18 of the projection device 10 is projected on the scene.

Advantageously, each projection device 10 comprises a common optical filtering assembly 22 comprising an optical filter 24 or several superimposed optical filters 24, the optical filtering assembly 22 being arranged to filter the light emitted by each light source 16, 18 of this projection device 10.

The optical filtering assembly 22 is preferably configured to generate the structured light pattern associated with each light source 16, 18 when this light source 16, 18 emits light.

In one example embodiment, the optical filtering assembly 22 defines a respective set of through zones 26, 28 associated with each light source 16, 18 of the projection device 10. Each light source 16, 18 has an associated respective set of through zones 26, 28 dedicated to this light source 16, 18.

The through zones 26, 28 associated with each light source 16, 18 of the projection device 10 are separate from the through zones 26, 28 associated with each other light source 16, 18 of the projection device 10.

Preferably, the optical filter 24 comprises opaque zones 30, each opaque zone 30 being configured to block the light emitted by each light source 16, 18 of the projection device 10.

The through zones 26, 28 associated with each light source 16, 18 of the projection device 10 are configured to allow the passage of the light generated by this light source 16, 18 and to block the light generated by each other light source 16, 18 of the projection device 10.

Light generated by each light source 16, 18 of the projection device 10 passes through the through zones 26, 28 associated with this light source 16, 18, and the light generated by this light source 16, 18 is blocked by each zone 26, 28 associated with each other light source 16, 18, and if applicable, by each opaque zone 30.

The through zones 26, 28 associated with each light source 16, 18 are distributed over the optical filter 24 so as to form the structured light pattern associated with this light source 16, 18. Each projection device 10 is configured to project a respective structured light pattern associated with each light source when a light source is illuminated, each other light source of the projection device 10 being extinguished.

Each projection device 10 has, respectively for each of its light sources 16, 18, an operating configuration in which this light source 16, 18 is illuminated and each other light source 16, 18 is extinguished, so as to project the structured light pattern associated with this illuminated light source.

Advantageously, the projection device 10 is configured to simultaneously project at least two structured light patterns generated by distinct light sources 16, 18 of the projection device 10.

A combined structured light pattern results for example from the combination of two elementary structured light patterns or more than two elementary structured light patterns.

The simultaneous projection of several structured light patterns to form a combined structured light pattern allows the simultaneous detection, in one or several images captured during the production of the combined structured light pattern, of several characteristics of the scene.

Each projection device 10 optionally has at least one operating configuration in which several light sources 16, 18 are illuminated simultaneously so as to project the structured light patterns associated with these illuminated light sources, to project a combined structured light pattern.

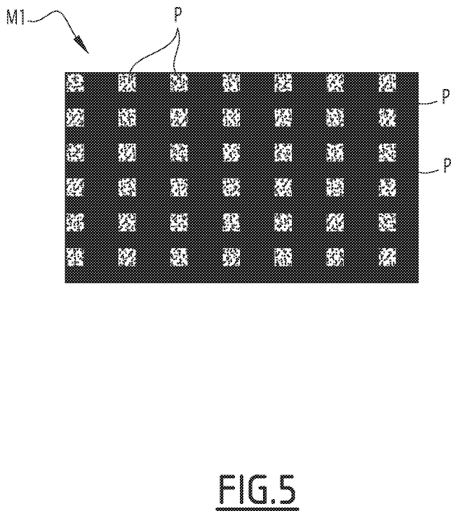

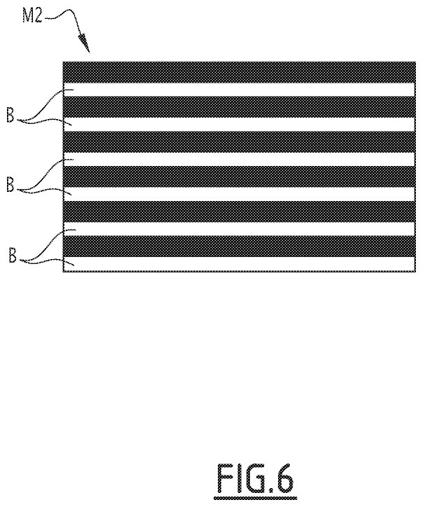

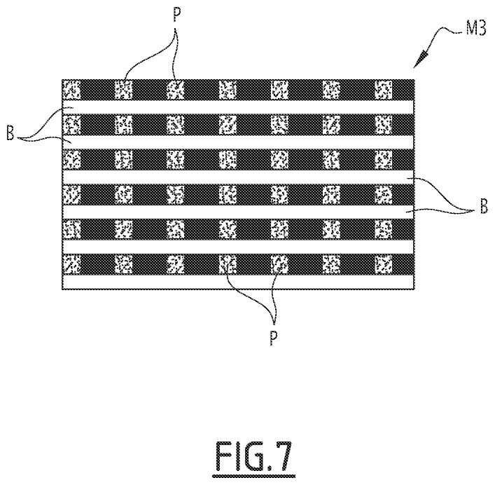

As illustrated in FIGS. 3 to 6, in one particular example embodiment, a projection device 10 comprises two light sources 16, 18, namely a first light source 16 to form a first structured light pattern M1 (FIG. 5) and a second light source 18 to form a second structured light pattern M2 (FIG. 6).

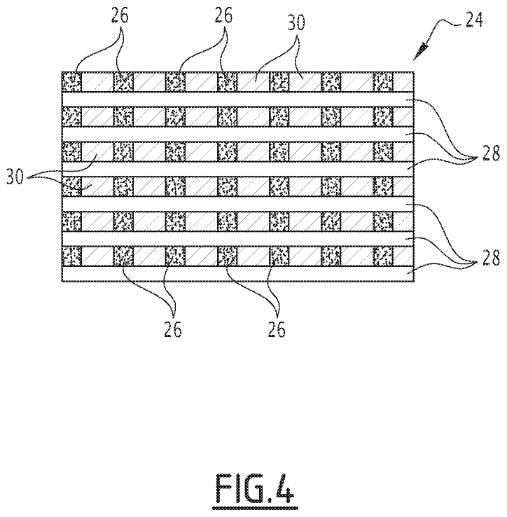

As visible in FIG. 4, the optical filter 26 comprises first through zones 26 configured to allow light emitted by the first light source 16 to pass while blocking the light emitted by the second light source 18 in order to form the first light pattern M1, and second through zones 28 configured to allow light emitted by the second light source 18 to pass while blocking the light emitted by the first light source 16 in order to form the second light pattern M2.

The optical filtering assembly 22 optionally defines opaque zones 30 blocking the light emitted by the first light source 16 and the light emitted by the second light source 18.

The first through zones 26, the second through zones 28 and, if applicable, the opaque zones 30 are separate from one another.

In the illustrated example, the first structured light pattern M1 comprises a matrix of light points P (in white in FIG. 4) spaced apart from one another while forming rows of points and columns of points, and the second structured light pattern M2 comprises parallel bands comprising alternating white bands B (in gray in FIG. 5) and non-illuminated or dark bands (in black in FIG. 5).

As illustrated in FIG. 6, the first structured light pattern M1 and the second structured light pattern M2 can be superimposed by simultaneously activating the first light source 16 and the second light source 18 to form a combined structured light pattern M3.

The illuminated bands of the second structured light pattern M2 are located between the rows of points of the first structured light pattern M1 and the non-illuminated bands of the second structured light pattern M2 are superimposed on the rows of points of the first structured light pattern M1. The light points P are situated in the gaps between the light bands B.

In the combined structured light pattern M3, the remaining non-illuminated zones (in black in FIG. 6 and corresponding to the opaque zones 30 of the optical filtering assembly 22) are situated between the light points P of the rows of points of the first structured light pattern M1.

Each projection device 10 having a first light source 16 and a second light source 18 has a first operating configuration in which the first light source 16 is illuminated and the second light source 18 is extinguished to project only the first structured light pattern M1, and a second operating configuration in which the first light source 16 is extinguished and the second light source 18 is illuminated to project only the second structured light pattern M2, and optionally, a third operating configuration in which the first light source 16 and the second light source 18 are illuminated simultaneously so as to project the first and second structured light patterns M1, M2 to form the combined structured light pattern M3.

Preferably, each projection device 10 is configured to project structured light patterns formed by light outside the visible domain, in particular formed by light in the near infrared domain.

The visible domain corresponds to the wavelengths comprised between 380 nm and 780 nm. The near infrared domain corresponds to the wavelengths comprised between 780 nm and 1400 nm.

To do this, advantageously, each light source 16, 18 of each projection device 10 is configured to emit light in the near infrared domain, preferably without emitting light in the visible domain.

Optionally, the optical filtering assembly 22 is configured to allow light to pass in the near infrared domain and to block light in the visible domain.

Returning to FIG. 1, the electronic control unit 12 is configured to analyze the images of the scene captured by the image capture apparatus 8, in particular based on the structured light pattern(s) projected on the scene by each projection device 10, to determine characteristics of the scene.

The analysis of the captured images is for example done so as to analyze the superposition of the scene and the projected pattern(s). This analysis makes it possible to map the pattern(s) and the objects in the scene, in particular to produce a three-dimensional (“3D”) map or a three-dimensional reconstruction of the scene from the captured images.

To measure the position of points of interest from the captured images, the electronic control unit 12 is for example configured to quantify the distortion of the pattern(s) projected on the captured images and to calculate, based on the distortion of the pattern(s), the relative depth of point(s) of interest relative to a reference object associated with each point of interest, for example the relative depth of the eyes of a user relative to his headrest or the relative depth of the head of an occupant relative to the image capture apparatus 8.

The electronic control unit 12 comprises an image analysis module 32 configured to perform the analysis of the images captured by the image capture apparatus 8.

In one example embodiment, the electronic control unit 12 comprises a processor 34 and a memory 36, the image analysis module 32 being a software application recordable in the memory 36 and executable by the processor 34 when it is recorded in the memory 36.

In a variant, the image analysis module 32 is a programmable software component, for example a field programmable gate array (FPGA) or an application-specific integrated circuit (ASIC).

Advantageously, the electronic control unit 12, and in particular the analysis module 32, is configured to transmit a signal to one or several functional members of the vehicle based on the characteristics of the detected scene.

A signal transmitted by the electronic control unit 12 is for example a signal for indicating a fatigue state of the driver, indicating a lack of attention of the driver, indicating the absence of an occupant after a stop of the motor vehicle 2, indicating a missing seatbelt, indicating discomfort of an occupant of the vehicle, indicating a change of driver, indicating a driver located outside a safe zone, performing facial recognition, detecting a gestural command, detecting a forgotten object, etc.

An alert signal is for example sent to one or several device(s) able to generate a stimulus perceptible by the driver, such as a display device of the dashboard, a device for emitting sounds and/or a device for generating vibrations, for example in a driver's seat or in the steering wheel.

As previously indicated, each projection device 10 is advantageously offset in the passenger compartment 4 relative to the image capture apparatus 8. In other words, each projection device 10 is positioned in the passenger compartment 4 at a distance from the image capture apparatus 8.

In one example embodiment, each projection device 10 is positioned on a front lateral upright 38 (or “upright A”) of the vehicle 2 or near a front lateral corner of the roof lining of the vehicle 2.

As illustrated in FIG. 1, when the detection system 6 comprises two projection devices 10, each projection device 10 is for example positioned on a respective front lateral upright 38 of the vehicle 2 or near a respective front lateral corner of the roof lining of the vehicle 2.

During operation, the projection system 9 projects a structured light pattern on the scene, using one or several projection device(s) 10, the image capture apparatus 8 captures one or several images of the scene during the production of the structured light pattern, and the data processing unit 12 analyzes the captured images to determine characteristics of the scene.

The projection system 9 next changes the projected structured light pattern, for example deactivating one projection device 10 and activating another projection device, or using another combination of light sources of a projection device 10 configured to project different light patterns, for example by deactivating one of the light sources of this projection device 10 and/or activating another light source of this projection device 10, then the image capture device 8 captures one or several image(s) of the scene during the production of the new structured light pattern, and the electronic control unit 12 analyzes the images captured to determine the characteristics of the scene.

In other words, the projection system 9 changes the structured light pattern projected during the detection done by the detection system 6 in order to detect different characteristics of the scene.

For each projected structured light pattern, the image capture apparatus 8 captures one or several image(s) before the projection system 9 changes projected structured light patterns.

The detection of each characteristic can be done in one image or in a sequence of images.

Detecting a characteristic in a sequence of images for example makes it possible to detect a movement by an occupant, for example a movement of an occupant's hand, in particular a movement of the hand corresponding to a gestural command.

In one example embodiment, the projection system 9 is configured to project structured light patterns according to a repeated or cyclical sequence of patterns, in particular a predetermined sequence of patterns.

Advantageously, each structured light pattern of the sequence is associated with a projection time or a number of captured images before going to the following structured light pattern of the sequence.

In one example embodiment, during the projection method, the projection system 9 sequentially projects a first elementary structured light pattern M1, a second elementary structured light pattern M2 and a combined structured light pattern M3 resulting from the superposition of the first elementary structured light pattern M1 and a second elementary structured light pattern M2. The projection is done in this order or in a different order, optionally according to a repeated sequence of patterns.

The provision of one or several projection device(s) 10 offset relative to the image capture apparatus 8, i.e., separate from the latter and positioned at a distance therefrom, allows the image capture apparatus 8 to be positioned appropriately to capture images 8 and allows each projection device 10 to be positioned appropriately relative to the scene to project one or several structured light pattern(s).

Each projection device 10 offset relative to the image capture apparatus 8 can in particular be positioned so as to be closer to a particular object of the scene, for example an occupant of the scene. This makes it possible to improve the contrast of each pattern projected on the scene, and thus to improve the analysis of the images captured by the image capture apparatus 8, and also to improve the resolution, since the projection device 10 is closer to the object and the light elements of each projected structured light pattern are more dense per surface unit on the object.

Providing one or several offset projection device(s) 10 also makes it possible to provide each projection device 10 with a reduced bulk or a shape factor appropriate for its integration in the desired location in the passenger compartment 4.

Each projection device 10 provided in the form of a projection unit separated from the image capture apparatus 8 can easily be integrated into an interior trim element of the vehicle 2, for example a front lateral upright, the roof lining, or a steering wheel, an airbag cover, a dashboard, a seat backrest, an armrest, a dashboard, etc.

Each projection device 10 provided in the form of a projection unit separated from the image capture apparatus 8 can be situated near a region of the scene intended to be illuminated by this projection device, which allows the power and therefore the energy consumption of the projection device 10 to be reduced.

Moreover, the possibility of projecting different structured light patterns makes it possible to perform an efficient detection in the passenger compartment, by allowing easy detection of different characteristics through the use of different structured light patterns projected on the scene, adapted to the detection of these different characteristics.

In particular, providing at least one projection device 10 comprising several light sources, in particular two light sources, emitting a respective structured light pattern using each light source, makes it possible to detect different characteristics of the scene using a single projection device 10.

It is possible to form the structured light patterns using a same optical filtering assembly common to the light sources of the projection device and also to combine the structured light patterns by projecting them simultaneously.

Using light sources emitting light in separate wavelength ranges allows structured light patterns projected simultaneously to be distinguished.

Furthermore, projecting structured light patterns with light in the near infrared domain prevents this light from being visible by the occupants of the vehicle. It is possible to project each structured light pattern with a relatively high power without disturbing the occupant(s).

This also makes it possible to position each projection device 10 behind a trim element of the vehicle that is transparent to light in the near infrared domain without being transparent to light in the visible domain, such that this retains little or no visibility for the occupants of the vehicle 2.

The invention is not limited to the example embodiments and the variants described above. Other example embodiments and other variants are conceivable.

Furthermore, providing a projection device 10 comprising at least two light sources to project a respective light pattern using each light source is advantageous independent of providing a projection device that is offset relative to the image capture apparatus 8.

Thus, according to another aspect, the invention also relates to a detection system for a vehicle passenger compartment, the detection system comprising an image capture apparatus configured to capture images of a scene located in the passenger compartment, a projection system configured to project structured light on the scene, the projection system comprising a projection device comprising at least two light sources and configured to project a respective structured light pattern using each light source, the structured light pattern projected using each light source being different from that projected using each other light source of the projection device, and an electronic control unit configured to analyze images captured using the image capture apparatus during the projection of structured light patterns.

According to specific embodiments, the detection system comprises one or more of the following optional features:

each light source of the projection device is configured to emit light in a respective wavelength range, different and preferably separate from that of each other light source of the projection device;
the projection device comprises an optical filtering assembly common to the light sources of the projection device, arranged to filter the light emitted by each light source of the projection device;
the optical filtering assembly defines, for each light source of the projection device, through zones allowing light emitted by this light source to pass and zones blocking the light emitted by this light source so as to form the structured light pattern associated with this light source.
the through zones associated with each light source are separate from the through zones associated with each other light source of the projection device;
the projection device is configured to emit a combined structured light pattern generated using at least two of the light sources of this projection device, by simultaneously projecting the structured light patterns associated with these light sources;
the projection device assumes the form of a module separated from the image capture apparatus so as to be mounted in the passenger compartment while being offset relative to the image capture apparatus;
the projection device is positioned on a lateral upright or a roof of the motor vehicle while being offset from the image capture apparatus.

1. A detection system for a vehicle passenger compartment, the detection system comprising an image capture apparatus configured to capture images of a scene located in the passenger compartment, a projection system configured to project structured light on the scene, the projection system comprising at least one projection device, each projection device being separate from the image capture apparatus so as to be mounted in the passenger compartment while being offset relative to the image capture apparatus, each projection device being configured to project at least one structured light pattern, and an electronic control unit configured to analyze images captured using the image capture apparatus during the projection of one or several structured light pattern(s).

2. The detection system according to claim 1, wherein the projection system is configured to project at least two different structured light patterns.

3. The detection system according to claim 2, wherein the projection system is configured to emit each of the structured light patterns in a respective range of wavelengths, separate from that of each other structured light pattern.

4. The detection system according to claim 1, wherein the projection system comprises at least two separate projection devices, each of the projection devices being configured to emit a structured light pattern different from the structured light pattern emitted by each other projection device.

5. The detection system according to claim 4, wherein each of the projection devices is configured to emit a structured light pattern in a range of wavelengths separate from that in which the structured light pattern projected by each other projection device is projected.

6. The detection system according to claim 1, wherein at least one projection device of the projection system is configured to emit at least two different structured light patterns.

7. The detection system according to claim 1, wherein at least one projection device is configured to emit at least two different light patterns in separate respective wavelength ranges.

8. The detection system according to claim 6, wherein at least one or each projection device configured to emit at least two different light patterns comprises at least two light sources, the projection device being configured to emit each structured light pattern using a respective light source among the light sources of the projection device.

9. The detection system according to claim 8, wherein each light source is configured to emit light in a respective wavelength range, different from that of each other light source of the projection device.

10. The detection system according to claim 8, wherein at least one or each projection device configured to emit at least two different light patterns is configured to emit a combined structured light pattern generated using at least two of the light sources of this projection device, by simultaneously projecting the elementary structured light patterns associated with these light sources.

11. The detection system according to claim 1, wherein at least one projection device of the projection system comprises an optical filtering assembly arranged to filter light emitted by one or each light source of this projection device.

12. The detection system according to claim 11, wherein the optical filtering assembly defines, for the or each light source of the projection device, through zones allowing light emitted by this light source to pass and zones blocking the light emitted by this light source so as to form the elementary structured light pattern associated with this light source.

13. The detection system according to claim 12, wherein the projection device having at least two light sources, the through zones associated with each light source are separate from the through zones associated with each other light source of the projection device.

14. The detection system according to claim 1, wherein the electronic control unit is configured to analyze the images captured by the image capture apparatus so as to detect the presence and/or the absence of a person or an animal in the vehicle after the vehicle is stopped, to detect physical and/or physiological parameters of a person or an animal present in the vehicle and/or to detect signs of fatigue or inattention by a driver, to detect the presence of an object in the passenger compartment, in particular interior layout elements of the vehicle, to detect a seatbelt not worn by an occupant, to detect discomfort by an occupant of the vehicle, to detect a change of driver, to detect a driver located outside a safe zone, to perform facial recognition of one or several occupant(s), in particular of the driver, to detect a gestural command and/or to detect the absence of a forgotten object.
